(19) United States
(12) Patent Application Publication
(10) Pub. No.: US 2017/0190378 A1
(43) Pub. Date: Jul. 6, 2017

(54) FOLDING BICYCLE

(71) Applicant: Acton, Inc., Mountain View, CA (US)

(72) Inventors: Peter Treadway, Sunnyvale, CA (US); Janelle Wang Treadway, Sunnyvale, CA (US); Kefan Hu, Santa Clara, CA (US)

(21) Appl. No.: 15/395,007

(22) Filed: Dec. 30, 2016

Related U.S. Application Data
(60) Provisional application No. 62/275,193, filed on Jan. 5, 2016.

(51) Int. Cl. B62K 15/00; B62H 5/00; B62M 6/65; B62J 6/02; B62J 99/00; B62K 3/04; B62H 3/00

(52) U.S. Cl. CPC B62K 15/008; B62K 3/04; B62H 5/00; B62H 3/00; B62J 6/02; B62J 99/00; B62M 6/65; B62K 2015/003; B62J 2099/0013; B62J 2099/002; B62J 2099/004

(57) ABSTRACT

A bicycle includes a top tube coupled with a front wheel and with at least a first pivot pair, the first pivot pair being rotatably coupled with a first end of a first arm and a first end of a second arm and a rear chainstay coupled with a rear wheel and with at least a second pivot pair, the second pivot pair being rotatably coupled with a second end of the first arm and a second end of the second arm. The first and second pivot pairs and the first and second arms enable the rear chainstay to move towards the top tube to a first position for folding the bicycle, and to move away from the top tube to a second position for unfolding the bicycle.

### CROSS REFERENCE TO RELATED APPLICATION

The present application is based on and claims the benefit of priority to U.S. Provisional Application No. 62/275,193, filed on Jan. 5, 2016, the entire contents of which are incorporated herein by reference.

### TECHNICAL FIELD

This disclosure relates generally to a bicycle. More specifically, it relates to a folding bicycle.

### BACKGROUND

Bicycles are commonly used as recreational or sporting equipment. Some bicycles can be folded to become more compact in size, and to improve portability. A conventional folding bicycle includes a folding joint at the top tube, which allows the bicycle frame to be folded laterally so that the front and rear wheels can overlap. FIG. 1 illustrates a conventional folding bicycle 100 in a folded state. As shown in FIG. 1, folding bicycle 100 includes a folding joint 102 which allows top tube 104 to be folded along axis A, so that wheels 106 and 108 can overlap with each other, and a length of the bicycle along axis B can be reduced.

While the folding mechanism in FIG. 1 reduces a length of bicycle 100 (measured along axis A) when it is in a folded state, the folded bicycle can become very thick (measured along axis B), especially when both the front fork (e.g., front fork 110 of FIG. 1) and the chainstay (e.g., chainstay 112 of FIG. 1) are both double-sided. Here, “double-sided” can refer that the front fork (and the chainstay) has two arms, with each arm coupled to opposite sides of the wheel hub. When the two wheels overlap, the two arms of the fork and the two arms of the chainstay will add to the thickness of the folded bicycle. Moreover, since the top tube must support the weight of the rider, the folding joint at the top tube must also be strong enough to support the weight of the rider. As a result, the folding joint at the top tube is typically very large, which further adds to the thickness of the folded bicycle. As a result, the top tube typically contributes predominantly to the thickness of a folded convention bicycle.

Therefore, it is desirable to develop an improved folding bicycle to reduce the thickness of the bicycle in a folded state, so that the folded bicycle can be even more compact and portable than conventional folding bicycles.

### BRIEF DESCRIPTION OF THE DRAWINGS

The accompanying drawings, which constitute a part of this specification, illustrate several embodiments and, together with the description, serve to explain the disclosed principles.

FIG. 1 illustrates a conventional folding bicycle in a folded state.

FIG. 2 illustrates one view of an exemplary folding bicycle, according to some embodiments of the present disclosure.

FIGS. 3A and 3B illustrate a folding mechanism of the exemplary folding bicycle of FIG. 2, according to some embodiments of the present disclosure.

FIGS. 4A and 4B illustrate a folding mechanism of the exemplary folding bicycle of FIG. 2, according to some embodiments of the present disclosure.

FIG. 5 illustrates another view of the exemplary folding bicycle of FIG. 2, according to some embodiments of the present disclosure.

FIGS. 6A and 6B illustrate mechanisms of storing and transporting the exemplary folding bicycle of FIG. 2, according to some embodiments of the present disclosure.

FIG. 7 illustrates a block diagram of an exemplary electronic system for a bicycle, according to some embodiments of the present disclosure.

FIG. 8 illustrates an exemplary interface for bicycle usage management, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. As used herein and in the appended claims, the singular forms “a,” “an,” and “the” include plural references unless the context clearly dictates otherwise.

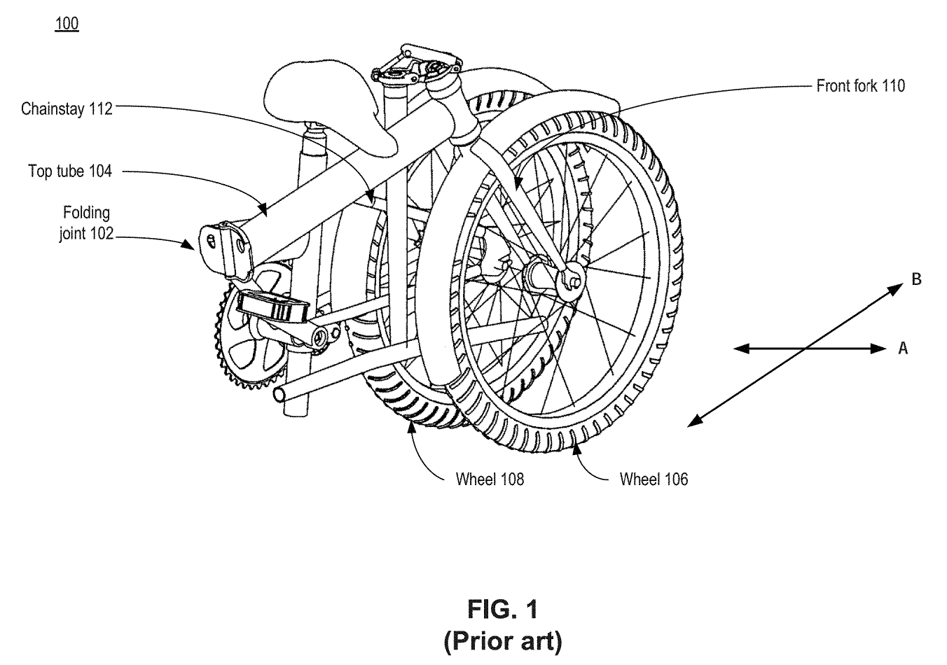

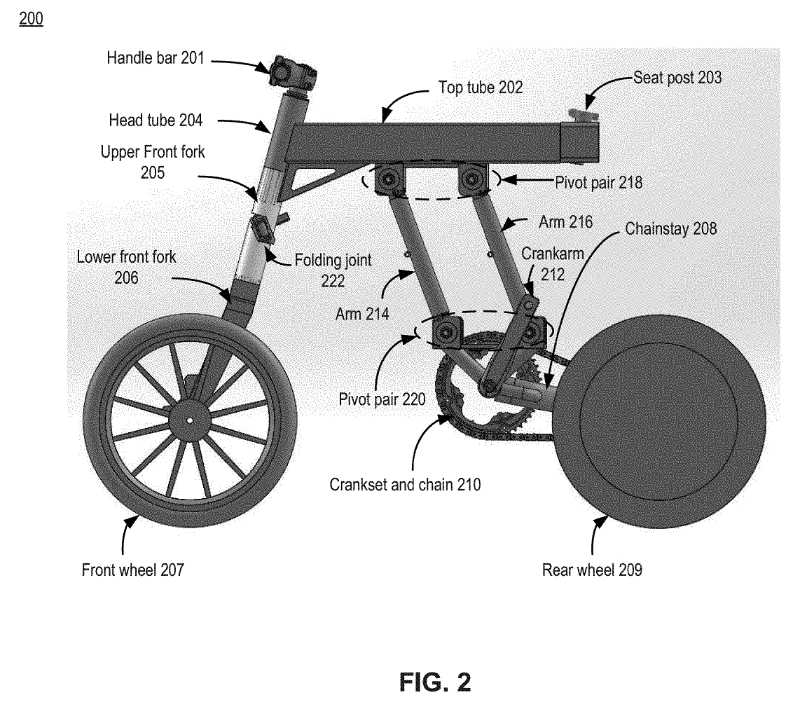

FIG. 2 illustrates a lateral view of an exemplary bicycle 200 according to some embodiments of the present disclosure. As shown in FIG. 2, bicycle 200 includes a top tube 202 connected to a seat post 203 configured to support a seat (not shown in FIG. 1). Top tube 202 is coupled to, via head tube 204, upper front fork 205 and lower front fork 206. Lower front fork 206 is single-sided and includes one arm configured to couple to front wheel 207 on one side. Upper front fork 205 is also coupled to handle bar 201, which can be used to steer front wheel 207. In some embodiments, upper front fork 205 can also include a suspension column configured to provide cushion and to improve riding experience.

Top tube 202 is also coupled to chainstay 208, which is also single-sided and is coupled to rear wheel 209 on the same side as wheel 207. Chainstay 208 can be coupled to crankset and chain 210 configured to drive rear wheel 209, and to crankarm 212 configured to drive crankset and chain 210. As shown in FIG. 1, top tube 202 is coupled to chainstay 208 via arms 214 and 216, and pivot pairs 218 and 220. As to be discussed below, Arms 214 and 216, together with pivot pairs 218 and 220, can be configured to move chainstay 208, rear wheel 209, crankset and chain 210, and crankarm 212 towards or away from top tube 202, to fold or to unfold bicycle 200.

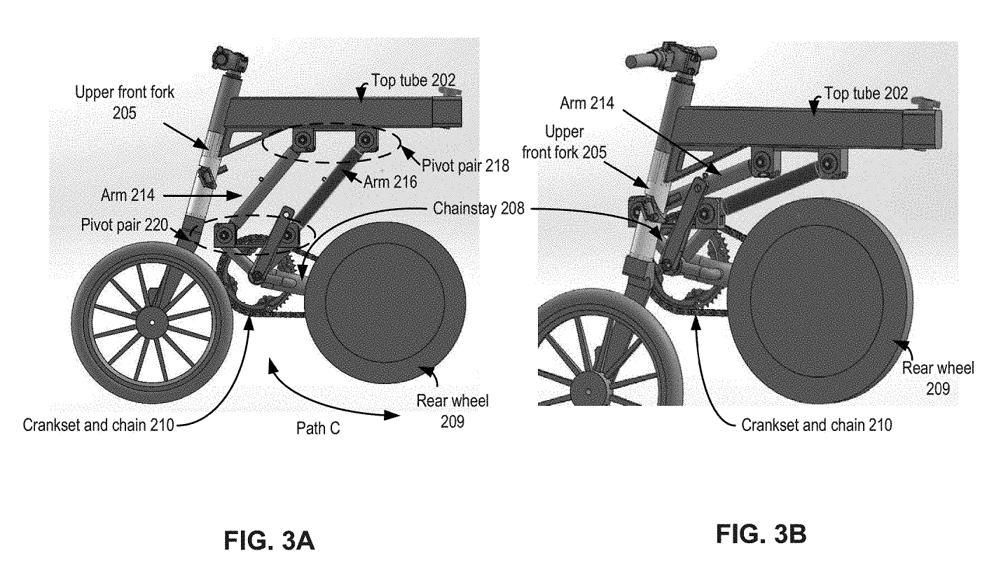

Reference is now made to FIGS. 3A and 3B, which illustrate a folding mechanism of bicycle 200 involving arms 214 and 216. As shown in FIG. 3A, a first end of arm 214 and of arm 216 can rotate around pivot pair 218, while a second end of arm 214 and of arm 216 can rotate around pivot pair 220. The rotating action can cause chainstay 208, rear wheel 209, and crankset and chain 210 to move along path C, to move either towards top tube 202 (when the bicycle is being folded), or away from top tube 202 (when the bicycle is being unfolded). Arms 214 and 216 may or may not be configured to be substantially parallel to each other during the rotating action. In some embodiments, as shown in FIG. 3B, at a folded state, at least part of chainstay 208, arm 214, and pivot pairs 220 can be positioned on one side of upper front fork 205, to further reduce the distance between rear wheel 209 and top tube 202, so that a size of bicycle 200 in the folded state can be further reduced.

In the unfolded state, arms 214 and 216 are configured to support the weight of top tube 202 as well as a rider sitting on a seat on seat post 203. Arms 214 and 216 can be made of any material with sufficient strength to support the weight, such as aluminum, plastic, composite, or any combination of these materials. In some embodiments, each of arms 214 and 216 can also include a suspension column configured to provide cushion, to improve riding experience. Further, arms 214 and 216 may or may not include different structures and different materials, and can have different dimensions. Although the figures in the present disclosure show that two arms are used to provide a folding mechanism, it is understood that any number of arms can be used to bring chainstay 208, rear wheel 209, and crankset and chain 210 to the aforementioned folded state.

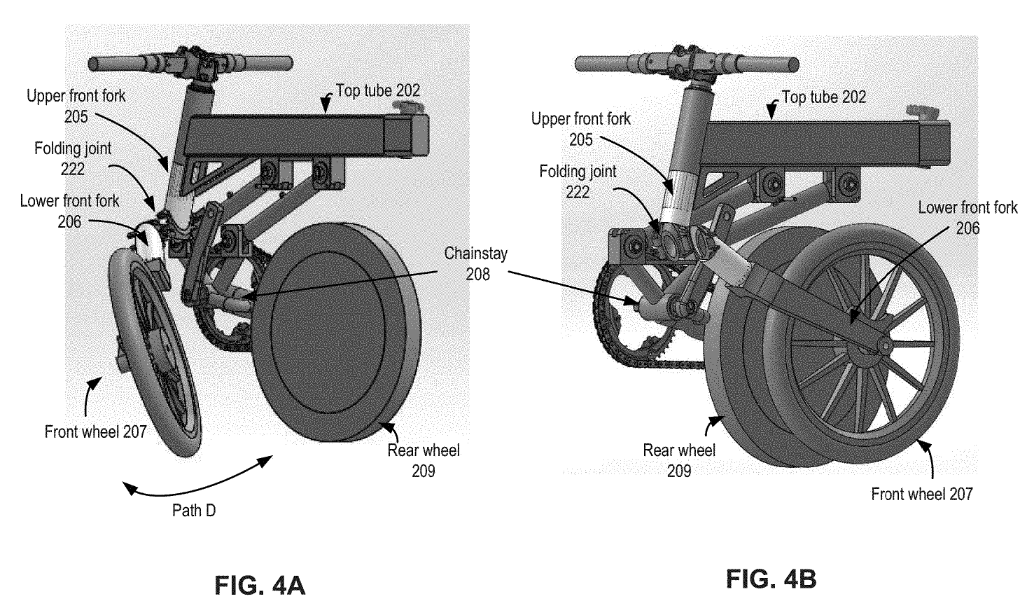

Referring back to FIG. 2, bicycle 200 can also include other features to further reduce the size when in a folded state. For example, handle bar 201 can be retracted and/or folded, and pedals (not shown in FIG. 1) can also be folded, to further reduce the size of the folded bicycle. Further, as shown in FIG. 1, upper front fork 205 and lower front fork 206 are coupled together via a folding joint 222. When folding joint 222 is released, as shown in FIG. 4A, lower front fork 206 (as well as front wheel 207) can remain hingedly coupled to upper front fork 205. Lower front fork 206 can be rotated, around a hinge of folding joint 222, along path D, towards or away from rear wheel 209. In a folded state, as shown in FIG. 4B, lower front fork 206 can be positioned such that at least part of front wheel 207 overlaps with rear wheel 209. Also, as discussed before, at a folded state shown in FIG. 3B, at least part of chainstay 208, arm 214, and pivot pairs 220 can be positioned on one side of upper front fork 205. With lower front fork 206 also in a folded state, as shown in FIG. 4B, lower front fork 206 can be positioned on another side of upper front fork 205 opposite to at least part of chainstay 208. Also, due to that each of lower front fork 206 and chainstay 208 is single-sided, they can be configured such that when front wheel 207 and rear wheel 209 are respectively in a folded state, as shown in FIG. 4B, the two wheels can become sandwiched between lower front fork 206 and chainstay 208.

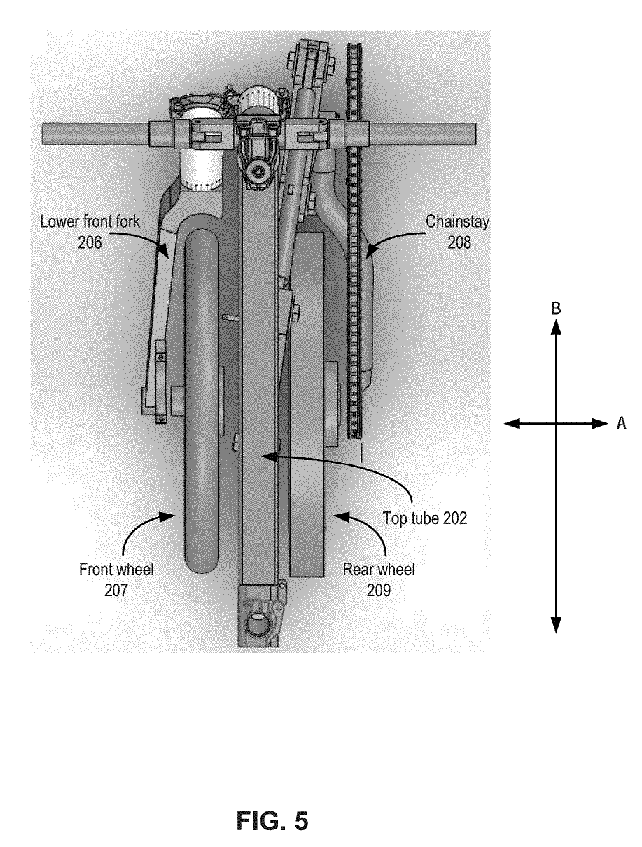

The orientations of front wheel 207 and rear wheel 209 with respect to lower front fork 206, chainstay 208, and top tube 202 are further illustrated in FIG. 5, which shows a top-down view of bicycle 200 when both the front wheel 207 and rear wheel 209 are in a folded state. As shown in FIG. 5, when bicycle 200 is in a folded state, front wheel 207 and rear wheel 209 can be brought together to reduce a length of the folded bicycle along the B axis. Also, with single-sided front fork and chainstay, the separation between front wheel 207 and rear wheel 209 in a folded state, along the A axis, can also be reduced. Also, since top tube 202 is not folded, it can be made thinner and contribute less to the thickness of a folded bicycle. With thinner wheels, front fork and chainstay, the thickness of bicycle 200 in a folded state, measured along the A axis, can be reduced. As a result, a folded bicycle 200 can become more compact and portable than conventional folding bicycles.

In some embodiments, bicycle 200 can include one or more electrical motors configured to facilitate the folding mechanism. For example, motors can be installed at pivot pairs 218 and 220 to rotate (or to assist in rotating) arms 214 and 216. Also, one or more motors can be installed at folding joint 222 to rotate (or to assist in rotating) lower front fork 206. Further, one or more motors can also be used to extend (or retract) and fold (or unfold) handle bar 201. In some embodiments, as to be discussed below, the motors can be controlled and coordinated by a processor to perform a sequence of actions for the folding (or unfolding) mechanisms. As an illustrative example, under the control of the processor, rear wheel 209 can first be moved, by the rotating actions of arms 214 and 216, towards (or from) a folded position (e.g., as indicated in FIG. 3B). And then front wheel 207 can be moved, by the rotating action of lower front fork 206, towards (or from) a folded position (e.g., as indicated in FIG. 4B). Handle bar 201 can also be retracted and folded (or extended and unfolded), before, after, or during the aforementioned rotating actions.

In some embodiments, the folding (or unfolding) mechanisms can be controlled by an external event. For example, bicycle 200 can include one or more buttons, or can be controllable wirelessly from a remote device (e.g., a remote controller, a smart phone running an app configured to control bicycle 200, etc.). Upon detecting the pressing of the one or more buttons, or receiving wireless control signals from the remote device, the folding (or unfolding) mechanisms can start. Further, the processor can also be configured to provide a locking mechanism to prevent unauthorized usage of bicycle 200. For example, at least one of front wheel 207, rear wheel 209, and handle bar 201 can be prevented from moving away from their folded positions when bicycle 200 is in a folded state, based on control signals from the processor to the aforementioned motors. The locking mechanism can also be released upon detecting an external event, such as receiving wireless control signals from the remote device, etc.

Moreover, bicycle 200 can also include a motor for cruising assistance. For example, a motor can fit inside rear wheel 209 (e.g., as a hub motor) that can drive the wheel, to provide cruising assistance to the rider. The motor can be configured to be narrower than the tire width of rear wheel 209 and does not add to the width of the wheel, to further reduce the width of bicycle 200 in a folded state.

In some embodiments, bicycle 200 can also include one or more lighting devices (not shown in the figures). The lighting devices can be located on head tube 204 and around top tube 202 to provide illumination not only ahead of bicycle 200 but also around the bicycle, to improve the effect of illumination in an environment of low visibility.

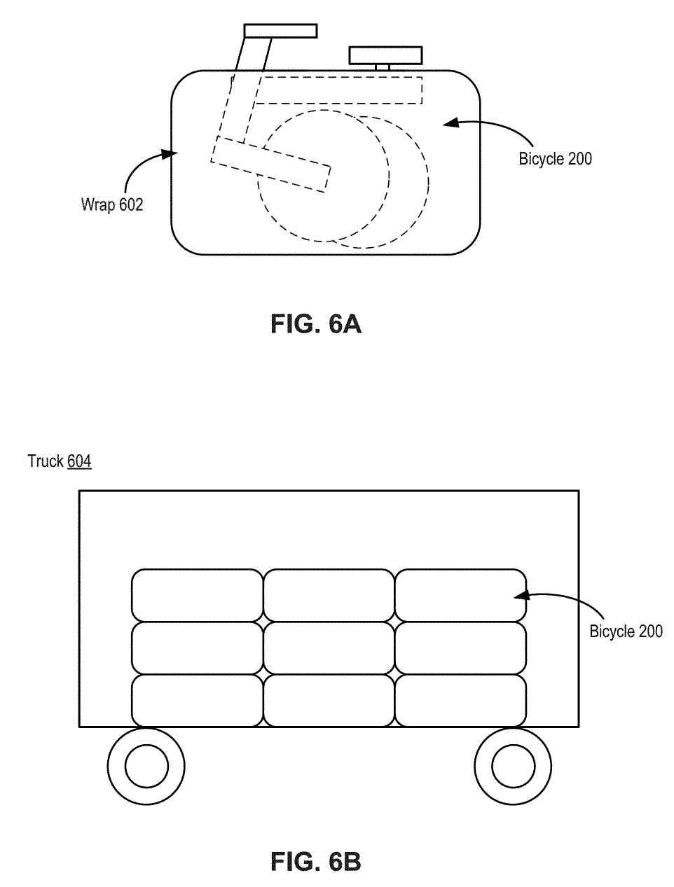

FIGS. 6A and 6B illustrate mechanisms of storing and transporting the bicycle 200, according to some embodiments of the present disclosure. As shown in FIG. 6A, at least part of folded bicycle 200, including front wheel 207 and rear wheel 209, can be put inside a wrap 620. Wrap 620 can be made of any material (e.g., metal, plastic, composite material, etc.) and can include a handle (not shown) to be hand carried like a luggage. Such an arrangement allows folded bicycle 200 to be hand-carried without the wheels of bicycle 200, which can be dirty, touching the ground, and can be prevent the wheels of bicycle 200 from leaving dirt on a floor when it is hand-carried indoor or on public transportation. Also, due to the compactness of folded bicycle 200, they can be stacked (either with our without wrap 620). This allows easy transportation and distribution of folded bicycle 200. For example, as shown in FIG. 6B, folded bicycle 200 can be stacked and transported on a truck 604.

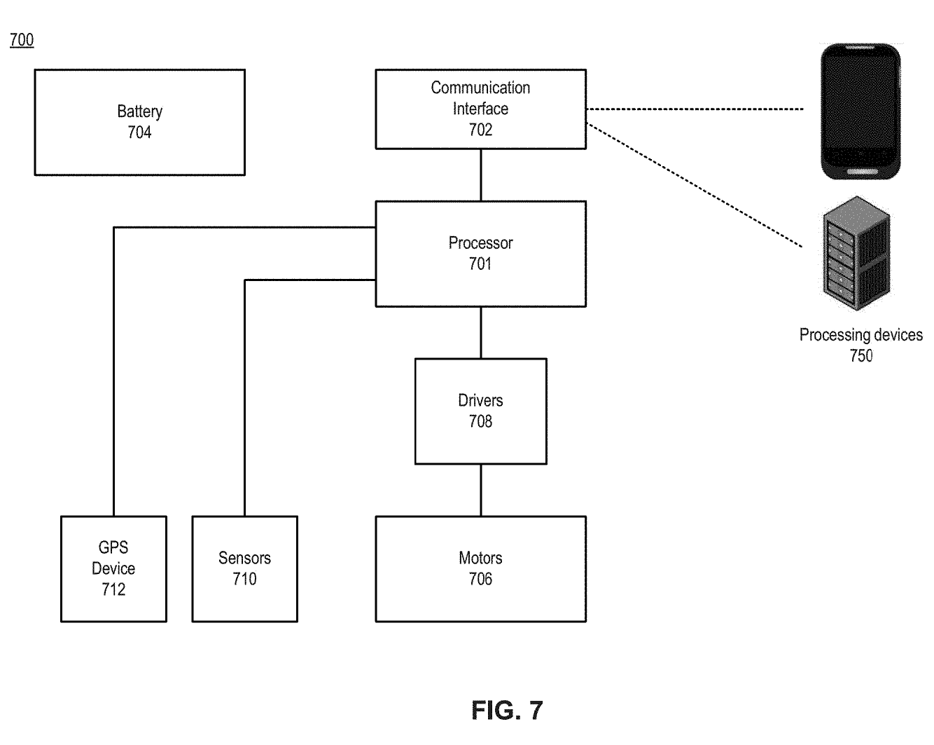

FIG. 7 illustrates a functional block diagram of an exemplary electronic system 700 for a bicycle, according to some embodiments of the present disclosure. In some embodiments, system 700 can be used to control and monitor one or more components of bicycle 200. As shown in FIG. 7, system 700 may include a processor 701, a communication interface 702, a battery 704 configured to provide power to each of the components of system 700, one or more motors 706, one or more drivers 708 configured to drive motors 706, and one or more sensors 710. Processor 701 may be a microprocessor, a microcontroller, a micro control unit (MCU), or other suitable processing units capable of performing computational/logical operations. Processor 701 may issue control signals to drivers 708 to control motors 706. For example, motors 706 can be installed at pivot pairs 218 and 220 and arms 214 and 216 of bicycle 200 to implement (or to assist) a folding mechanism, and processor 701 may be configured to control and coordinate motors 706 to perform a sequence of steps for the folding mechanism. Processor 701 may also issue control signals to drivers 708 to implement a locking mechanism by controlling and coordinating motors 706 to, for example, maintain front wheel 207 and rear wheel 209 in their folded positions, until the locking mechanism is released.

Processor 701 may also receive, from sensors 710, signals that reflect an action of the bicycle. For example, sensors 710 may include a speedometer, a gyroscope, etc., configured to measure a speed of movement of the bicycle. In some embodiments, system 700 may also include a global positioning system (GPS) 712 configured to provide location information of the bicycle to processor 701. Processor 701 can also determine a status of the bicycle based on the speed and location information. For example, processor 701 can receive an indication (e.g., from communication interface 702, or from other interfaces not shown in FIG. 7) that the bicycle is to remain in a stationary state at a certain location (e.g., at a storage kiosk), and that the locking mechanism has not yet been released. If processor 701 detects that during the stationary state, the location of the bicycle changes (e.g., based on data from GPS device 712 or sensors 710), processor 701 can determine that the bicycle has been stolen. Processor 701 can provide the speed information and location information of the bicycle, as well as information about the status of the bicycle (e.g., that the bicycle is stolen), to communication interface 702. Communication interface 702 can be any wireless interface (e.g., Bluetooth, WiFi, etc.) configured to transmit the information received from processor 701 to a processing device 750 (e.g., a server), which can then provide the information to a client device (e.g., a smart phone). In some embodiments, communication interface 702 can also transmit the information received from processor 701 directly to a client device as well.

In some embodiments, system 700, including battery 704, can be disposed inside a top tube of a bicycle (e.g., top tube 202). For example, battery 704 can be disposed on a platform slidably fitted into top tube 202, and can be slid out from one end of top tube 202 (e.g., opposite to head tube 204) to be swapped or replaced. Top tube 202 can also include connectors configured to charge battery 704.

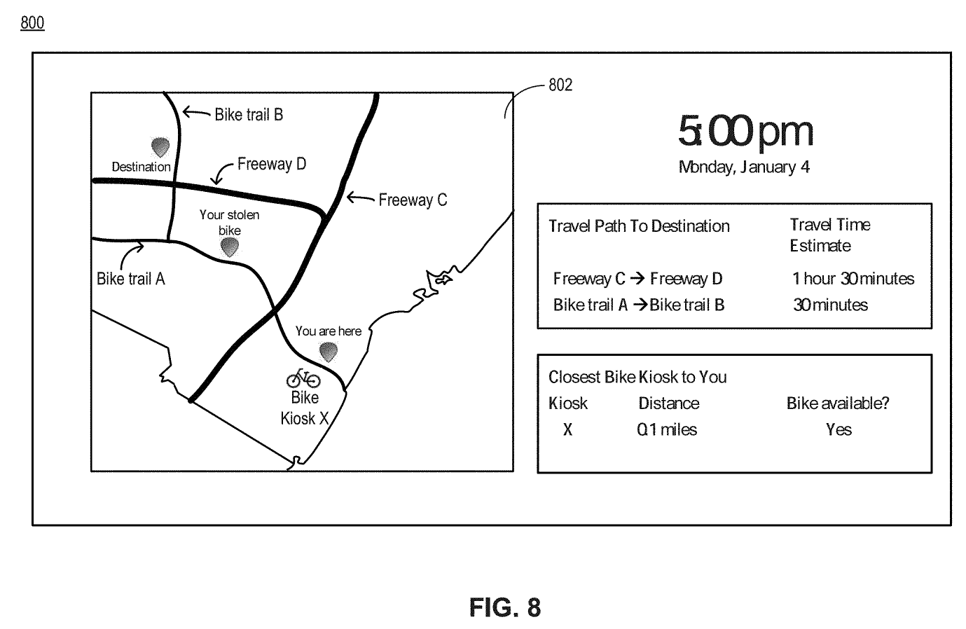

FIG. 8 illustrates an exemplary interface 800 for bicycle usage management, according to some embodiments of the present disclosure. In some embodiments, interface 800 can be provided by an app running on a client device (e.g., a smart phone), which can receive information from a server that processes the speed, location, and status information of a bicycle, and present the information through interface 800.

In some embodiments, interface 800 can be configured to provide trip planning information for both driving and biking. For example, the client device can receive location information of a user (e.g., from a GPS device embedded in the receiver device), and destination information from the user. The client device can also receive traffic information on freeways (e.g., freeways C and D), as well as on bike trails A and B. The traffic information on bike trails A and B can be generated based on speed and location information received from bicycles that include system 700 of FIG. 7, while the traffic information on freeways can be based on information received from other traffic reporting services (e.g., Google Map™). The client device can determine various options for the routes for the user to get to the destination (e.g., via freeways or bike trails), and estimate the travel time for each option based on, for example, the speed and location information of the bicycles on the bike trails. Interface 800 can display the relative locations between the user and the destination in a map 802, as well as the suggested routes and associated travel time estimate. In some embodiments, the determination of locations, routes, travel time, etc. can also be performed at a server, which can then provide the information for displaying in interface 800.

Interface 800 can also provide other information to the user. For example, interface 800 can display information about kiosk (e.g., bike kiosk X as shown in FIG. 8) from which the user can rent a bicycle. The information can include, for example, inventory information at the kiosk, distance between the kiosk and the user, etc. Also, as discussed before, system 700 may allow a user to track a status of a bicycle. For example, in a case where system 700 determines that a bicycle is stolen, system 700 can transmit status information indicating that the bicycle is stolen to a server, which can then process the location information of the bicycle (e.g., received from GPS device 712) and display the location of the stolen bicycle on map 802.

The specification has described a folding bicycle. The illustrated diagrams are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A bicycle, comprising:
a top tube coupled with a front wheel and with at least a first pivot pair, the first pivot pair being rotably coupled with a first end of a first arm and a first end of a second arm;
a rear chainstay coupled with a rear wheel and with at least a second pivot pair, the second pivot pair being rotatably coupled with a second end of the first arm and a second end of the second arm;
wherein the first and second pivot pairs and the first and second arms enable the rear chainstay to move towards the top tube to a first position for folding the bicycle, and to move away from the top tube to a second position for unfolding the bicycle.

2. The bicycle of claim 1, wherein the top tube is coupled to the front wheel via an upper front fork and a lower front fork; wherein the upper front fork is coupled to the lower front fork at a folding joint; wherein the folding joint enables the lower front fork to be rotated to cause the front wheel to move towards the rear wheel for folding the bicycle, and to move away from the rear wheel for unfolding the bicycle.

3. The bicycle of claim 1, further comprising one or more motors configured to rotate the first and second arms around the first and second pivot pairs.
